(19) United States
(12) Patent Application Publication
(10) Pub. No.: US 2006/0070704 A1
(43) Pub. Date: Apr. 6, 2006

(54) Vaccum support and transfer of flexible material

(75) Inventors: Christopher J. Sinclair, Alpharetta, GA (US); Kenneth M. Stockwell, Cary, IL (US)

Correspondence Address: RYNDAK & SURI LLP, 200 W MADISON STREET, SUITE 2100, CHICAGO, IL, 60602, US

(73) Assignee: Tropicana Products, Inc.

(21) Appl. No.: 10/959,762

(22) Filed: Oct. 6, 2004

(51) Int. Cl. B65C 9/08; B25B 11/00; B32B 37/00

(52) U.S. Cl. 156/539; 269/21; 156/569; 156/570

(57) ABSTRACT

A transfer assembly and method for transferring a flexible sheet of material which is subject to wrinkling, folding and/or creasing. The assembly and method includes a vacuum manifold having a cavity which is connected to an evacuation source for drawing a vacuum on the cavity, and an opening on the manifold of a given size and shape and communicating with the cavity. A sheet of porous material for supporting the flexible sheet of material for transfer thereon covers the opening and has a plurality of fine pores extending therethrough. The pores are profusely and uniformly distributed entirely over an area of the sheet of porous material which area is at least substantially of the same size and shape as the flexible sheet of material which is to be transferred thereon, so that substantially the entire area of the flexible sheet of material which is to be transferred is exposed to the pores. The pores are subjected to the vacuum in the manifold cavity in the substantial absence of impairment of communication of the vacuum to the pores to uniformly pickup and hold the flexible sheet of material for transfer without folding, wrinkling or creasing of the flexible sheet of material.

### BACKGROUND AND SUMMARY OF THE INVENTION

The present invention is directed to a vacuum support device and method for the pickup, support, manipulation, transfer and/or delivery of a flexible sheet of material without wrinkling, folding or creasing the material.

Various assemblies and methods have been employed in the past for the support and transfer of a sheet of material from one location to another. In many of these a vacuum has been employed in the pickup of the sheet of material to hold and support the material and transfer and deliver it to a different location. For example, in prior labeling assemblies a vacuum has been employed to lift a label from a holder or magazine containing a stack of labels and transfer the label either to a container itself or to a mold in which the label is to be applied to a container upon molding of the container.

Some of these support and transfer assemblies have employed vacuum support and transfer heads or manifolds in which a vacuum is drawn on a face on the head or manifold to draw the flexible sheet toward the head and hold it on the face. For example, in Priest et al. U.S. Pat. No. 4,049,484 a vacuum head is disclosed which has a face of polyurethane foam rubber together with at least one base to support the porous polyurethane foam rubber face. However, the base is generally solid in nature and has spaced passages therethrough to communicate the vacuum in the cavity of the head to the porous layer at only spaced locations on the porous layer.

Laverriere U.S. Pat. No. 4,389,064 also discloses a gripping head having a face of porous material through which a vacuum grips and holds the sheet of material to be manipulated. However, the principal vacuum or suction is exposed to the face through spaced passages through the porous material to the sheet of material to be picked up and held, and the suction or vacuum is further channeled by spaced openings through a base plate which communicate the vacuum in the cavity of the head to the spaced passages through the porous material.

Due to the non-uniform and generally localized application of suction to the sheet material which is to be picked up, supported, manipulated, transferred and/or delivered because of these spaced passages, the aforementioned gripping and/or transfer heads are not suitable for use for the pickup, support, manipulation, transfer and/or delivery of thin flexible sheets of material which are subject to wrinkling, folding or creasing.

It has been discovered in the present invention that where such flexible sheets of materials which are subject to wrinkling, folding and/or creasing are to be picked up, supported, manipulated, transferred and/or delivered, this can be successfully done without such wrinkling, folding and/or creasing. In the present invention, a vacuum is drawn through a sheet of porous material which has a plurality of fine pores extending through the porous material and in which the pores are profusely and uniformly distributed substantially over an area of the sheet of porous material which area is at least substantially of the same size and shape as the flexible sheet of material which is to be picked up, supported, manipulated, transferred and/or delivered thereon so that the entire area of the flexible sheet of material which is to be transferred is uniformly exposed to the pores and the vacuum. In the assembly and method of the present invention there is also a substantial absence of any impairment of communication of the vacuum to the pores of the porous sheet of material. In such assembly and method the vacuum uniformly holds the flexible sheet of material which is to be picked up, supported, manipulated, transferred and/or delivered without folding, wrinkling or creasing of the flexible sheet of material.

In one principal aspect of the present invention, a transfer assembly for transferring a flexible sheet of material which is subject to wrinkling, folding and/or creasing comprises a vacuum manifold having a cavity and which is adapted to be connected to an evacuation source for drawing a vacuum on the cavity of the manifold, and an opening on the manifold of a given size and shape and communicating with the cavity. A sheet of porous material for supporting the flexible sheet of material for transfer thereon has a size and shape at least substantially the same as the given size and shape of the opening and covers the opening. The sheet of porous material has a plurality of fine pores extending therethrough, the pores being profusely and uniformly distributed substantially entirely over an area of the sheet of porous material which area is at least substantially of the same size and shape as the flexible sheet of material which is to be transferred thereon, whereby substantially the entire area of the flexible sheet of material which is to be transferred is exposed to the pores. The pores of the sheet of porous material which covers the opening are subjected to the vacuum in the manifold cavity and in the substantial absence of impairment of communication of the vacuum to the pores to uniformly pickup and hold the flexible sheet of material for transfer without folding, wrinkling or creasing of the flexible sheet of material.

In another principal aspect of the present invention, a method of moving a flexible sheet of material which is subject to wrinkling, folding and/or creasing, comprises providing a vacuum manifold having a cavity, an opening of a given size and shape which communicates with the cavity, and a sheet of porous material for supporting the flexible sheet of material thereon which is to be moved. The porous material has a size and shape at least substantially the same as the given size and shape of the manifold opening and covers the opening, and has a plurality of fine pores extending therethrough. The pores are profusely and uniformly distributed substantially entirely over an area of the sheet of porous material which area is at least of substantially of the same size and shape as the flexible sheet of material which is to be moved, whereby substantially the entire flexible sheet of material which is to be moved is exposed to the pores. The manifold is moved into overlying relationship to the flexible sheet of material which is to be moved, and a vacuum is drawn on the cavity to move the flexible sheet of material which is to be moved to the porous sheet of material and hold it thereon in the substantial absence of impairment of communication of the vacuum to the pores to uniformly pickup and hold the flexible sheet of material on the sheet of porous material without folding, wrinkling or creasing of the flexible sheet of material.

In still another principal aspect of the present invention, the transfer assembly and method includes a substantially rigid support adjacent the opening and between the sheet of porous material and the cavity, and the support has small openings profusely and uniformly distributed thereon to support the sheet of porous material in the absence of substantial impairment of communication of the vacuum between the cavity and the pores of the sheet of porous material.

In still another principal aspect of the present invention, in the transfer assembly and method the support has a size and shape at least substantially the same as the opening.

In still another principal aspect of the present invention, in the transfer assembly and method the support comprises a mesh sheet.

In still another principal aspect of the present invention, in the transfer assembly and method the sheet of porous material is selected from the group consisting essentially of a non-woven fibrous material, a woven material and/or a foamed material.

In still another principal aspect of the present invention, in the transfer assembly and method the sheet of porous material is curved.

In still another principal aspect of the present invention, the transfer assembly and method the sheet of porous material is substantially flat.

In still another principal aspect of the present invention, in the transfer assembly and method a pickup station includes a holder which holds a supply of a plurality of the flexible sheets of material which are subject to wrinkling, folding and/or creasing, and a receiving station receives at least one of the flexible sheets of material from the holder. A delivery mechanism moves the manifold between a first position in which the manifold removes at least one of the flexible sheets of material from the holder by drawing the flexible sheet of material against the sheet of porous material, and a second position in which the manifold positions the removed flexible sheet of material at the receiving station.

In still another principal aspect of the present invention, in the transfer assembly and method the flexible sheets of material are labels.

In still another principal aspect of the present invention, in the transfer assembly and method the receiving station contains a container and the label is applied to the container.

In still another principal aspect of the present invention, in the transfer assembly and method the receiving station is a container mold, and the label is positioned in the container mold to be applied to the container upon molding of the container in the mold.

These and other objects, features and advantages of the present invention will be more clearly understood upon consideration of the following detailed description.

### BRIEF DESCRIPTION OF THE DRAWING

In the course of this description, reference will frequently be made to the attached drawing in which:

FIG. 1 is a schematic view of a transfer assembly and method for the pickup, holding, transfer and delivery of a thin flexible label which is delivered to a blow mold for the application of the label to a generally cylindrical container upon molding of the container;

FIG. 2 is a schematic view of a transfer assembly and method for the pickup, holding, transfer and delivery of a thin flexible label to the exterior of a generally rectangular in cross section container having a flat face; and

FIG. 3 is an exploded view of the somewhat curved, porous material and support on the face of the vacuum manifold of the assembly shown in FIG. 1 together with the flexible label which is to be picked up, held, transferred and delivered on the porous material.

### DESCRIPTION OF THE PREFERRED EMBODIMENTS

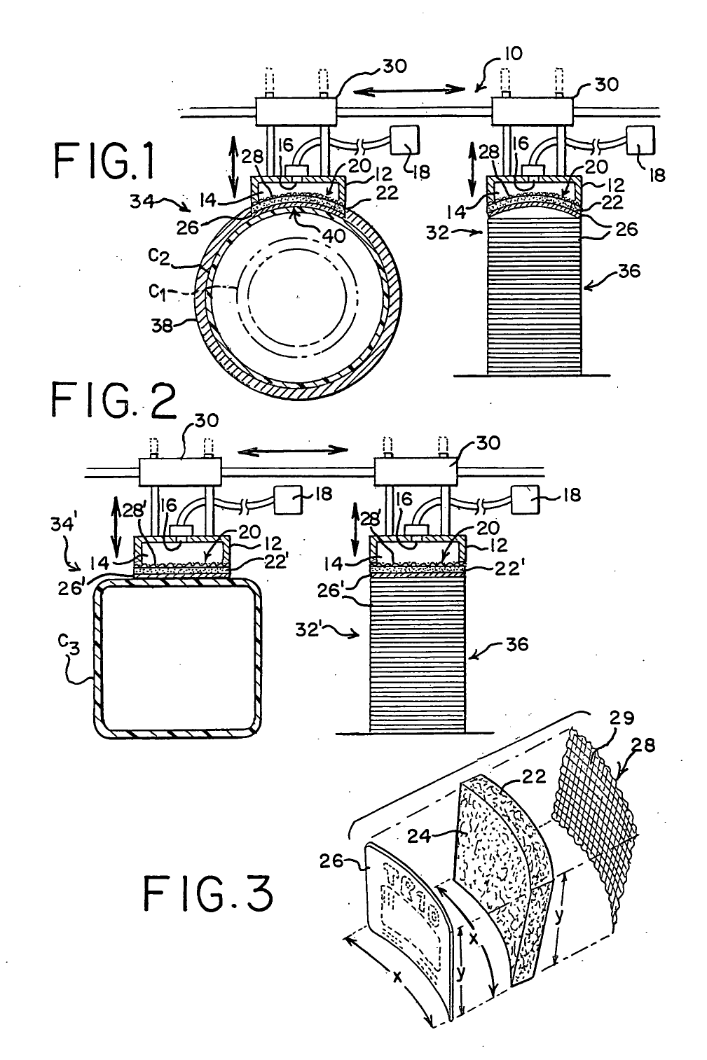

With particular reference to FIGS. 1 and 3, one preferred embodiment is shown in schematic of a transfer assembly and method of the present invention for the pickup, support, transfer and delivery of a flexible sheet of material which is subject to wrinkling, folding and/or creasing. The transfer assembly 10 includes a vacuum manifold 12 defining a cavity 14 to which an opening 16 communicates the cavity to an evacuation source 18, such as a vacuum pump. The lower face of the manifold 12 as viewed in the drawings also includes an opening 20 to the cavity 14.

The opening 20 is of a given size and shape and is covered by a sheet of porous material 22 which also has a size and shape at least substantially the same as the given size and shape of the opening so that it covers the opening. The sheet of porous material 22 includes many fine pores 24 as shown in FIG. 3 which communicate through the thickness of the sheet of porous material. These pores 24 are profusely and relatively uniformly disbursed over an area x, y of the sheet of porous material 22 which area is at least substantially of the same size and shape x, y as the flexible sheet of material 26 which is to be picked up, supported, transferred and delivered. Because of this, substantially the entire area x, y of the flexible sheet of material 26, such as a thin label for a container, is exposed without any substantial interruptions to the vacuum through this profusion of pores to substantially reduce the possibility that the thin flexible label will become wrinkled, folded or creased during the pickup, holding, transfer or delivery of the label.

Although the area x, y containing the pores of the sheet of porous material is shown in FIG. 3 to be the entire size and shape of the sheet of porous material 22, it will be understood that the area in which the pores 24 are distributed may be smaller where the area x, y of the label 26 is smaller. What is important is that the area in which the pores 24 are distributed is shaped and at least as large to insure that substantially the entire area of the label 26 is exposed to the pores to minimize the possibility of wrinkling, folding or creasing of the label.

The sheet of porous material 22 may be formed of various materials which permit the profusion and uniform distribution of the fine pores over the sheet. These materials may include various fibrous non-woven materials, such as felt, or fibrous woven materials, such as textiles. The use of the term “fibrous” is not intended to be limited to organic or plant fibers, but can include fibrous metallic, ceramic or polymeric materials. The sheet of porous material 22 may also be formed of various other porous materials, such as polymeric foams, sponge metals or ceramics.

It is important in the present invention that the sheet of porous material 22 and its pores 24 are subjected to the vacuum in the manifold cavity 14 in the substantial absence of impairment of communication of the vacuum to the cavity side of the sheet of porous material. In that regard where the sheet of porous material 22 is formed of a material which has sufficient strength to support itself and maintain its shape when subjected to the vacuum, its cavity side face may be exposed directly to the vacuum in the cavity without any overlying additional support material which might otherwise impair or block the exposure to the sheet of porous material 22 and its pores 24 to the vacuum in the cavity 14. However, where the sheet of porous material 22 does not have sufficient strength to maintain its shape when exposed to the vacuum in the cavity 14, an additional support sheet 28 may be provided which is at least substantially of the same size and shape as the sheet of porous material 22 and label 26. Such support may be formed of metallic, ceramic or polymeric materials and preferably takes the form of a mesh as shown in the drawing so that it presents may small openings 29 profusely and uniformly distributed through the support thus avoiding any substantial impairment of communication of the vacuum between the cavity 14 and the pores 24 of the sheet of porous material 22.

The wide profusion and uniform distribution of the pores 24 over the sheet of porous material 22, and openings 29 of the support 28, are important in the present invention to insure that all portions of the surface of the label are evenly subjected to the vacuum to prevent wrinkling, folding or creasing of the thin, flexible labels 26. This wide profusion and uniform distribution of pores is in contrast to the vacuum heads or manifolds of the prior art as earlier mentioned in which the vacuum was communicated in a non-uniform manner to the face of the manifold by spaced passages through a porous material and/or support.

In the transfer assembly 10 shown in FIG. 1, the vacuum manifold 12 is constructed such that the sheet of porous material 22 and support 28 are curved and/or arcuate in shape to conform with the shape of the exterior surface of a container C₂ to which the label 26 is to be applied. In the transfer assembly and method shown in FIG. 1, the vacuum manifold 12 is mounted to some form of either mechanical or pneumatic delivery mechanism 30 so that the vacuum manifold 12 may be raised and lowered as shown by the vertical arrows and moved transversely as shown by the horizontal arrow between a pickup station 32 from which individual labels are picked up and held, and transferred to a delivery station 34 where they are to be applied to the container. As shown in FIG. 1 the pickup station 32 preferably comprises some form of holder such as a label magazine 36 which contains a stack of the labels 26, and the delivery station 34 may comprise a blow mold 38 having an opening 40 through which the manifold 12 positions the label 26 so that when the container C₁ is blown to its final container configuration C₂, the label 26 is applied to the container C₂.

The transfer assembly and method shown in FIG. 2 is substantially identical to that shown in FIG. 1 and, therefore, like reference numerals are employed to designate like components. The transfer assembly and method shown in FIG. 2 differs from that shown in FIG. 1 in that the label 26′ which is to be applied to the container, is picked up, held, moved and delivered to a generally rectangular in cross section container C₃ in a flat condition to apply the label directly to a flat face of the already formed rectangular container. Accordingly, the flat sheet of porous material 22′ and support 28′, and the pickup and delivery stations 32′ and 34′ are somewhat different than those shown in FIG. 1.

It will be appreciated that the transfer assembly and method shown in FIG. 1 in which a curved sheet of porous material 22 and label 26 are employed in an in-mold application can be just as readily employed for application of a flat label 26′ also in an in-mold application to the flat face of a generally rectangular cross section container during forming. Conversely, the out-of-mold application directly to a flat faced container as shown in FIG. 2 may also be employed to directly apply a cured label to a curved container in a out-of-mold application after the container has been formed.

It also will be understood that the preferred embodiments of the present invention which have been described are merely illustrative of the principles of the present invention. Numerous modifications may be made those skilled in the art without departing from the true spirit and scope of the invention.

We claim:

1. A transfer assembly for transferring a flexible sheet of material which is subject to wrinkling, folding and/or creasing, said assembly comprising:
a vacuum manifold having a cavity and which is adapted to be connected to an evacuation source for drawing a vacuum on the cavity of the manifold;
an opening on said manifold of a given size and shape and communicating with said cavity;
a sheet of porous material for supporting the flexible sheet of material for transfer thereon, said sheet of porous material having a size and shape at least substantially the same as said given size and shape of said opening and covering said opening, said sheet of porous material having a plurality of fine pores extending therethrough, said pores being profusely and uniformly distributed substantially entirely over an area of said sheet of porous material which area is at least substantially of the same size and shape as the flexible sheet of material which is to be transferred thereon, whereby substantially the entire area of the flexible sheet of material which is to be transferred is exposed to said pores; and
said pores of said sheet of porous material which covers said opening are subjected to the vacuum in said manifold cavity and in the substantial absence of impairment of communication of the vacuum to the pores to uniformly pickup and hold the flexible sheet of material for transfer without folding, wrinkling or creasing of the flexible sheet of material.

2. The transfer assembly of claim 1, including a substantially rigid support adjacent said opening and between said sheet of porous material and said cavity, said support having small openings profusely and uniformly distributed thereon to support said sheet of porous material in the absence of substantial impairment of communication of the vacuum between said cavity and said pores of said sheet of porous material.

3. The transfer assembly of claim 2, wherein said support has a size and shape at least substantially the same as said opening.

4. The transfer assembly of claim 3, wherein said support comprises a mesh sheet.

5. The transfer assembly of claim 2, wherein said support comprises a mesh sheet.

6. The transfer assembly of claim 2, wherein said sheet of porous material is selected from the group consisting essentially of a non-woven fibrous material, a woven material and/or a foamed material.

7. The transfer assembly of claim 1, wherein said sheet of porous material is selected from the group consisting essentially of a non-woven fibrous material, a woven material and/or a foamed material.

8. The transfer assembly of claim 1, wherein said sheet of porous material is curved.

9. The transfer assembly of claim 1, wherein said sheet of porous material is substantially flat.

10. The transfer assembly of claim 3, wherein said sheet of porous material is selected from the group consisting essentially of a non-woven fibrous material, a woven material and/or a foamed material.

11. The transfer assembly of claim 1, further including a
pickup station including a holder for holding a supply of a plurality of the flexible sheets of material which are subject to wrinkling, folding and/or creasing;
a receiving station for receiving at least one of said flexible sheets of material from said holder; and
a delivery mechanism for moving said manifold between a first position in which said manifold removes at least one of said flexible sheets of material from said holder by drawing said flexible sheet of material against said sheet of porous material, and a second position in which said manifold positions said removed flexible sheet of material at said receiving station.

12. The transfer assembly of claim 11, wherein said flexible sheets of material are labels.

13. The transfer assembly of claim 12, wherein said receiving station contains a container and said label is applied to said container.

14. The transfer assembly of claim 12, wherein said receiving station is a container mold, and said label is positioned in said container mold to be applied to the container upon molding of the container in the mold.

15. A method of moving a flexible sheet of material which is subject to wrinkling, folding and/or creasing, comprising:
providing a vacuum manifold having a cavity, an opening of a given size and shape which communicates with the cavity, and a sheet of porous material for supporting the flexible sheet of material thereon which is to be moved, said porous material having a size and shape substantially at least the same as said given size and shape of the opening and covering said opening, and having a plurality of fine pores extending therethrough, said pores being profusely and uniformly distributed substantially entirely over an area of the sheet of porous material which area is at least of substantially of the same size and shape as the flexible sheet of material which is to be moved, whereby substantially the entire flexible sheet of material which is to be moved is exposed to said pores;
moving said manifold into overlying relationship to the flexible sheet of material which is to be moved; and
drawing a vacuum on said cavity to move the flexible sheet of material which is to be moved to said porous sheet of material and hold it thereon in the substantial absence of impairment of communication of the vacuum in the cavity to the pores to uniformly pickup and hold the flexible sheet of material on the sheet of porous material without folding, wrinkling or creasing of the flexible sheet of material.

16. The method of claim 15, including supporting the sheet of porous material with a substantially rigid support adjacent said opening and between said sheet of porous material and said cavity, and in which said support has small openings profusely and uniformly distributed thereon to support said sheet of porous material in the absence of substantial impairment of communication of the vacuum between said cavity and said pores of said sheet of porous material.

17. The method of claim 16, wherein said support has a size and shape at least substantially the same as said opening.

18. The method of claim 17, wherein said support comprises a mesh sheet.

19. The method of claim 16, wherein said support comprises a mesh sheet.

20. The method of claim 16, wherein said sheet of porous material is selected from the group consisting essentially of a non-woven fibrous material, a woven material and/or a foamed material.

21. The method of claim 15, wherein said sheet of porous material is selected from the group consisting essentially of a non-woven fibrous material, a woven material and/or a foamed material.

22. The method of claim 15, wherein said sheet of porous material is curved.

23. The method of claim 15, wherein said sheet of porous material is substantially flat.

24. The method of claim 17, wherein said sheet of porous material is selected from the group consisting essentially of a non-woven fibrous material, a woven material and/or a foamed material.

25. The method of claim 15, including;
removing the flexible sheet of material which is to be moved from a holder for holding a supply of a plurality of said flexible sheets of material which are subject to wrinkling, folding and/or creasing; and
delivering the flexible sheet of material which has been removed to a receiving station.

26. The method of claim 25, wherein said flexible sheets of material are labels.

27. The method of claim 26, wherein said receiving station contains a container and said label is applied to said container.

28. The method of claim 26, wherein said receiving station is a container mold, and said label is positioned in said container mold to be applied to the container upon molding of the container in the mold.
